(19) United States
(12) Patent Application Publication
(10) Pub. No.: US 2010/0062189 A1
(43) Pub. Date: Mar. 11, 2010

(54) OPTICAL FILM, POLARIZING PLATE AND IMAGE DISPLAY DEVICE

(76) Inventors: Takatoshi Yosomiya, Tokyo (JP); Kazuaki Watanabe, Tokyo (JP); Naoko Maji, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/515,095

(22) PCT Filed: Nov. 19, 2007
(86) PCT No.: PCT/JP07/72390

§ 371 Date: May 15, 2009

(30) Foreign Application Priority Data
Nov. 17, 2006 (JP) 2006-312268
Oct. 4, 2007 (JP) 2007-261295
Oct. 4, 2007 (JP) 2007261297

(51) Int. Cl. C09K 19/00; C08F 4/42; C08K 5/1575; G02B 5/30

(52) U.S. Cl. 428/1.31; 526/170; 524/108; 359/485

(57) ABSTRACT

Provided are an optical film for a protection film for polarizer, excellent in optical properties such as small haze, excellent transparency and small birefringence, having good mechanical strength and heat resistance, and excellent in water vapor transmission rate; a polarizing film having the film as a protection film on one or both surfaces of a polarizer; and an image display device comprising the polarizing film. The optical film for a protection film for polarizer comprises a polypropylene-based resin produced with a metallocene catalyst.

### TECHNICAL FIELD

The present invention relates to an optical film for a protection film for polarizer, having excellent optical characteristics such as small haze, excellent transparency and small birefringence, having good mechanical strength and heat resistance, and having excellent water vapor transmission rate, to a polarizing film comprising the film as a protection film on one or both surfaces of the polarizer therein, and to an image display device comprising the polarizing film.

### BACKGROUND ART

A polarizing film is a material having the function of transmitting a light alone that has a specific oscillation direction but blocking the other light, and is widely used, for example, as a component of constituting a liquid-crystal display device. As the polarizing film of the type, generally used is one having a laminate constitution of a polarizer and a protection film. The polarizer has the function of transmitting a light alone that has a specific oscillation direction, for which, for example, generally used is a polyvinyl alcohol (hereinafter this may be referred to as “PVA”) film stretched and colored with iodine, a dichroic dye or the like. Recently, a coated polarizer has become used.

The protection film has the function of, for example, holding the polarizer and imparting a practicable strength to the whole polarizing film, for which, for example, generally used is a cellulose film such as a triacetyl cellulose (hereinafter this may be referred to as “TAC”) film. As having good transparency and small birefringence, a cellulose film is excellent in optical uniformity and has practicable heat resistance and excellent mechanical strength, and therefore it has excellent characteristics as a protection film for polarizer.

In addition, it has high water vapor transmission rate, and therefore, when stuck to a polarizer of PVA or the like, its workability is good in that the moisture transmission through it from PVA or adhesive is excellent, and it is generally used as a protection film for polarizer (e.g., see Patent Reference 1).

However, a cellulose film (e.g., TAC film) has high moisture absorbability and is therefore problematic in that it may detract from the property of polarizer and its dimensional stability may worsen owing to moisture absorption.

To solve the problems, a method has been tried for dimensional stability enhancement by using a film material having a smaller water absorption rate than that of conventional TAC films as a protection film for polarizer; however, a polycarbonate film and a polyethylene terephthalate film having a small water absorbability have a large photoelastic constant and may cause retardation change owing to the action of external stress given thereto, and are therefore problematic in that they may detract from the capability of polarizing films.

Given that situation, a monoaxially-stretched high-density polyethylene or polypropylene film having a low water vapor transmission rate has been proposed for the protection film for polarizer (e.g., see Patent Reference 2).

However, the monoaxially-stretched polyethylene or polypropylene film has retardation occurring therein and is therefore problematic in that it may worsen the function of polarizing films.

### [Patent Reference 1] JP-A 7-120617

### [Patent Reference 2] JP-B 6-12362

### BRIEF DESCRIPTION OF THE DRAWINGS

FIG. 1 It is a schematic view showing a process of producing a polarizing film of the present invention.

FIG. 2 It is a schematic view showing a constitution example of a liquid-crystal cell having a polarizing film of the present invention.

FIG. 3 It is a schematic view showing a constitution example of a resistance film-type touch panel (glass/glass type) having a polarizing film of the present invention.

FIG. 4 It is a schematic view showing a constitution example of a resistance film-type touch panel (glass/film type) having a polarizing film of the present invention.

### DESCRIPTION OF REFERENCE NUMERALS

1: Resin melt (PP)
2: Optical element
3: Polarizer
4: Protection film (optical film)
5: Adhesive layer
6: Liquid-crystal cell
7: polarizing film
8: Retardation film (birefringent layer)
9: Polarizing film of touch panel
10: Antireflection film
11: λ/4 plate
12: Protection film [upper side] of polarizer
12′: Protection film [lower side] of polarizer
13: Polarizer (PVA)
14: Glass
15: ITO protection film
16: Protection film [lower outer side] of polarizer
17: Polarizing film of touch panel

### DISCLOSURE OF THE INVENTION

### Problems that the Invention is to Solve

The present invention has been made in consideration of the above-mentioned problems, and its object is to provide an optical film for a protection film for polarizer, having excellent optical characteristics such as small haze, excellent transparency and small birefringence, having good mechanical strength and heat resistance, and having excellent water vapor transmission rate, a polarizing film comprising the film as a protection film on one or both surfaces of the polarizer therein, and an image display device comprising the polarizing film.

### Means for Solving the Problems

The present inventors have assiduously studied for the purpose of attaining the above-mentioned object and, as a result, have found that an optical film comprising a polypropylene-based resin produced with a metallocene catalyst is suitable to a protection film for polarizer, and can solve the above-mentioned problems.

Specifically, the present invention provides the following:

[1] An optical film for a protection film for polarizer, comprising a polypropylene-based resin produced with a metallocene catalyst;
[2] The optical film of above [1], wherein the polypropylene-based resin has a modulus of bending elasticity of at least 700 MPa;
[3] The optical film of above [1] or [2], wherein the polypropylene-based resin has a melt flow rate (MFR: measured under the condition of 230° C. and 2.16 kg load according to JIS K7210) of at least 20 g/10 min;
[4] The optical film of any one of above [1] to [3], wherein the optical film is an unstretched film;
[5] The optical film of any one of above [1] to [4], wherein a dibenzylidene sorbitol-based additive is further added in an amount of from 0.03 to 0.5 parts by mass relative to 100 parts by mass of the polypropylene-based resin;
[6] The optical film of any one of above [1] to [5], wherein the optical film has a retardation in the thickness direction thereof, Rth of from 20 to 60 nm;
[7] A polarizing film having the optical film of any one of above [1] to [6] formed on at least one surface of the polarizer therein; and
[8] An image display device comprising the polarizing film of above [7].

### EFFECT OF THE INVENTION

The optical film of the present invention has excellent optical characteristics such as small haze, excellent transparency and small birefringence, and is excellent in water vapor transmission rate. In addition, it is excellent in various durability such as heat resistance and wet heat resistance, and may enhance the degree of polarization of a polarizing film comprising it, not having any influence on the optical function thereof, and further, it is soft and rich in elasticity. Moreover, the optical film of the present invention is resistant to external shock and deformation, and therefore, when stuck to a polarizer, it gives a polarizing film capable of significantly enhancing the strength and the reliability of a liquid-crystal display device comprising it.

In addition, as compared with a TAC film heretofore generally and widely used in the art, the optical film of the present invention has a protective function comparable to or better than that of a TAC film. In particular, a TAC film is hydrophilic and has little water vapor transmission rate; however, the optical film of the present invention is hydrophobic and therefore can greatly enhance the durability of polarizing films comprising it.

### BEST MODE FOR CARRYING OUT THE INVENTION

The optical film of the present invention comprises a polypropylene-based resin produced with a metallocene catalyst.

The polypropylene-based resin for use in the present invention is produced with a metallocene catalyst to be mentioned hereinunder, and is preferably a copolymer of propylene and an α-olefin. The α-olefin includes ethylene and 1-olefins having from 4 to 18 carbon atoms, concretely ethylene, 1-butene, 1-pentene, 1-hexene, 1-octene, 1-heptene, 4-methyl-pentene-1,4-methyl-hexene-1, 4,4-dimethylpentene-1, etc. Preferably, the proportion of the propylene unit in the copolymer is at least 80 mol %, and that of the comonomer is at most 20 mol %. The comonomer is not limited to one type of the above-mentioned α-olefin, but two or more types thereof may be used to give a polynary copolymer such as a terpolymer.

The metallocene catalyst for use in the present invention may be a single-site catalyst where the active points are uniform, or a multi-site catalyst where the active points are not uniform; and above all, preferred is a multi-site catalyst. Generally used are a Group 4 to 6 transition metal compound with Zr, Ti, Hf or the like, especially a Group 4 transition metal compound, and an organic transition metal compound having a cyclopentadienyl group or a cyclopentadienyl derivative group.

The cyclopentadienyl derivative group includes an alkyl substituent group such as pentamethylcyclopentadienyl, or a group constituting a saturated or unsaturated cyclic substituent group through bonding of two or more substituent groups; typically an indenyl group, a fluorenyl group, an azulenyl group, or their partially-hydrogenated derivatives. Also preferred are those formed by bonding plural cyclopentadienyl groups via an alkylene group, a silylene group, a germylene group or the like.

As a co-catalyst, usable is at least one compound selected from a group consisting of aluminiumoxy compounds, ionic compounds capable of reacting with a metallocene compound to convert the metallocene compound ingredient into a cation, Lewis acids, solid acids and ion-exchanging layered silicates. If desired, an organoaluminium compound may be added along with any of those compounds.

The layered silicate is a silicate compound having a crystal structure where the constitutive layers are piled up in parallel to each other with a weak bonding force of ionic bonding or the like. In the present invention, the layered silicate is preferably ion-exchanging. Ion-exchanging as referred to herein means that the interlayer cation of the layered silicate is exchangeable. Most layered silicates of natural products are produced essentially as a main ingredient of clay minerals; however, the layered silicate for use herein is not specifically limited to naturally-produced ones but may be synthetic ones.

Concrete examples of layered silicates may be any known layered silicates with no specific limitation, including, for example, kaolin minerals such as dickite, nacrite, kaolinite, anauxite, metahalloysite, halloysite, etc.; surpentine minerals such as chrysotile, lizardite, antigorite, etc.; smectite minerals such as montmorillonite, zaukonite, viderite, nontronite, saponite, tainiolite, hectorite, stevensite, etc.; vermiculite minerals such as vermiculite, etc.; mica minerals such as mica, illite, sericite, glauconite, etc,; attapulgite; sepiolite; palygorskite; bentonite; pyrophyllite; talc; chlorite minerals. They may form a mixed layer.

Of those, preferred are smectite minerals such as montmorillonite, zaukonite, viderite, nontronite, saponite, hectorite, stevensite, bentonite, tainiolite, etc.; vermiculite minerals and mica minerals.

These layered silicates may be chemically treated. The chemical treatment may be any of surface treatment to remove the impurities adhering to the surfaces, or treatment to have some influence on the crystal structure and the chemical composition of the layered silicates. Concretely, it includes (a) acid treatment, (b) alkali treatment, (c) salt treatment, (d) organic substance treatment, etc. Through the treatment, the impurities may be removed from the surfaces; or interlayer cations may be exchanged; or the cations such as Al, Fe, Mg or the like may be released from the crystal structure to form ionic composites, molecular composites, organic derivatives or the like thereby changing the surface area, the interlayer distance, the solid acidity or the like. One or more of these treatments may be attained either singly or as combined.

The method (polymerization method) of producing a polypropylene-based resin with the above-mentioned metallocene catalyst includes a slurry method of using an inert solvent in the presence of the catalyst, a vapor-phase method not substantially using a solvent, a solution method, or a bulk polymerization method of using the polymerization monomer as a solvent, etc.

Next, the polypropylene-based resin in the present invention has a modulus of bending elasticity of at least 700 MPa, more preferably at least 900 MPa. When the resin has a modulus of bending elasticity falling within the above range, then the optical film comprising it may have a sufficient strength and may be readily post-worked.

Also preferably, the polypropylene-based resin in the present invention has a melt flow rate (hereinafter this may be referred to as MFR) of at least 20 g/10 min, more preferably from 20 to 40 g/10 min. MFR is determined according to JIS K7210, and the condition for measuring it is at 230° C. and under a load of 2.16 kg. When the polypropylene-based resin has MFR falling within the above range, the optical film comprising it may have a sufficient strength and may be readily post-worked. Further, the resin is hardly strained and therefore hardly expresses retardation; and in addition, its MFR may be readily stabilized in production lots and therefore it may be stably shaped. The amount of additive to it, such as an MFR controller may be reduced not having any negative influence on the physical properties of the resin. An ordinary MFR controller may be used for controlling the MFR of the polypropylene-based resin.

Preferably, the polypropylene-based resin in the present invention has a melting point (Tm) of not lower than 130° C. When the resin has a melting point (Tm) of not lower than 130° C., then it is favorable since the unstretched film comprising it may have a high modulus of elasticity and the strength of the optical film formed of it may increase not having any influence on the post-working of the film.

Also preferably, the polypropylene-based resin has a tensile strength of at least 20 MPa. When the tensile strength of the resin is at least 20 MPa, the optical film comprising it is not oriented and has no retardation, when stuck to a polarizer via an adhesive layer according to a roll-to-roll method, and therefore the resulting polarizing film may keep the property of the polarizer.

In the present invention, an additive may be added to the film for the purpose of increasing the tensile strength thereof and to enhance the transparency thereof. As the additive, preferred is a dibenzylidene sorbitol-based additive having little influence on the retardation of the film.

As the dibenzylidene sorbitol-based additive for use in the present invention, preferred are di-substituted dibenzylidene sorbitol such as 1,3-2,4-diparamethyldibenzylidene and sorbitol, 1,3-2,4-dibenzylidene sorbitol; and a combination of di-substituted benzylidene sorbitol and diglycerin monofatty acid ester, etc.

It is known that the dibenzylidene sorbitol-based additive contributes toward increasing the transparency and the strength of polypropylene resin, serving as a clearing nucleating agent. The inventors have found that when the additive is used in the optical film for protection films for polarizers in the present invention, it has little influence on the retardation of the film.

Of the above-mentioned dibenzylidene sorbitol-based additive, preferred is the diglycerin monofatty acid ester-added dibenzylidene sorbitol-based nucleating agent that is stable and bleeds little. The diglycerin monofatty acid ester is preferably diglycerin monolaurate, diglycerin monomyristate ester, diglycerin monostearate, etc. One or more of these may be used herein either singly or as combined.

The content of the above additive is preferably from 0.03 to 0.5 parts by mass relative to 100 parts by mass of the polypropylene resin. When the content is at least 0.03 parts by mass, the transparency and the strength of the film could be fully enhanced. On the other hand, even though the content is more than 0.5 parts by mass, it could not bring about any further enhancement of the transparency and the strength but may be rather disadvantageous in point of the cost.

In particular, when a diglycerin monofatty acid ester-added di-substituted dibenzylidene sorbitol is used, preferably, the amount of the di-substituted dibenzylidene sorbitol is from 0.01 to 0.3 parts by mass relative to 100 parts by mass of the polypropylene resin, and the amount of the diglycerin monofatty acid ester to be added is from 0.01 to 0.2 parts by mass.

Various olefin resins and additives may be added to the optical film of the present invention in accordance with the desired physical properties of the film and not detracting from the necessary transparency thereof.

The olefin resin may be homopolypropylene, random polypropylene or the like produced with a Ziegler catalyst, and it may be added in a small amount not more than 10% by mass.

The additives include, for example, weather resistance improver, abrasion resistance enhancer, polymerization inhibitor, crosslinking agent, UV absorbent, antistatic agent, adhesiveness enhancer, leveling agent, thixotropy-imparting agent, coupling agent, surfactant, polyelectrolyte, conductive complex, antiblocking agent, lubricant, plasticizer, defoaming agent, filler, solvent, etc.

As the weather resistance improver, usable is UV absorbent or light stabilizer.

The UV absorbent may be any of inorganic or organic substances. As the inorganic UV absorbent, preferred are titanium dioxide, cerium oxide, zinc oxide and the like having a mean particle size of from 5 to 120 nm or so. The organic UV absorbent includes, for example, benzotriazole-based compounds, concretely, 2-(2-hydroxy-5-methylphenyl)benzotriazole, 2-(2-hydroxy-3,5-di-tert-amylphenyl)benzotriazole, polyethylene glycol 3-[3-(benzotriazol-2-yl)-5-tert-butyl-4-hydroxyphenyl]prop ionate, etc.

On the other hand, the light stabilizer includes, for example, hindered amine-based compounds, concretely, bis(1,2,2,6,6-pentamethyl-4-piperidyl 2-(3,5-di-tert-butyl-4-hydroxybenzyl)-2′-n-butyl malonate, bis(1,2,2,6,6-pentamethyl-4-piperidyl) sebacate, tetrakis(2,2,6,6-tetramethyl-4-piperidyl)-1,2,3,4-butane-t etracarboxylate, etc.

Also usable are reactive UV absorbents and light stabilizers having a polymerizing group such as a (meth)acryloyl group in the molecule.

The abrasion resistance improver includes, for example, as inorganic substances, spherical particles of α-alumina, silica, kaolinite, iron oxide, diamond, silicon carbide, etc. Including spheres, ovals, polygons, flakes and the like, the morphology of the particles is not specifically defined, but is preferably spherical. As organic substances, the improver includes synthetic resin beads of crosslinked acrylic resin, polycarbonate resin or the like. The particle size may be generally from 30 to 200% or so of the thickness of the optical film. Of those, spherical α-alumina is especially preferred, as it has a high hardness and is greatly effective for enhancing the abrasion resistance of the film and as spherical particles are easily available.

The polymerization inhibitor includes, for example, hydroquinone, p-benzoquinone, hydroquinone monomethyl ether, pyrogallol, t-butylcatechol, etc.; the crosslinking agent includes, for example, polyisocyanate compound, epoxy compound, metal chelate compound, aziridine compound, oxazoline compound, etc.

The filler includes, for example, barium sulfate, talc, clay, calcium carbonate, aluminium hydroxide, etc.

The IR absorbent includes, for example, dithiol-based metal complex, phthalocyanine-based compound, diimmonium compound, etc.

Various additives may be added to the optical film for imparting various functions thereto, for example, for imparting thereto, hard coat function of having high hardness and high scratch resistance, as well as antifogging function, antifouling function, antiglare coat function, antireflection coat function, UV-blocking coat function, IR-blocking coat function, etc.

### [Method for Producing Optical Film]

A method for producing the optical film of the present invention is described below.

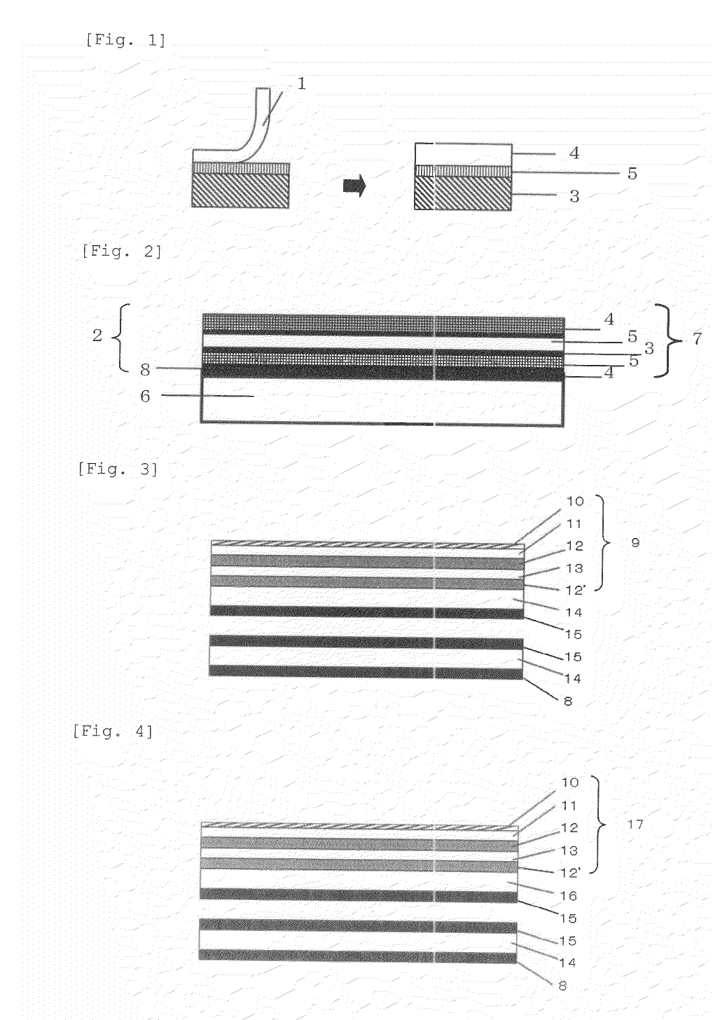

The optical film may be produced directly on a polarizer according to various shaping methods with the above-mentioned polypropylene-based resin of an extrusion coating molding method, a casting method, a T-die extrusion molding method, an inflation method, an injection molding method or the like (see FIG. 1). Alternatively, the optical film 4 is previously formed according to any of the above-mentioned shaping methods, and then it may be stuck to a polarizer via an adhesive layer.

In the present invention, the optical film to be formed on a polarizer is desired not to be oriented, for which, therefore, preferred is non-stretching T-die extrusion molding with no stretching given to the film being produced.

The thickness of the optical film is preferably within a range of from 10 to 200 μm, more preferably from 30 to 150 μm. When the thickness thereof is at least 10 μm, the film may have a strength enough for a protection film for polarizer; and when it is at most 200 μm, the film may have sufficient flexibility and, as lightweight, it is easy to handle, and it is advantageous in point of the cost.

FIG. 1 shows a method of forming an optical film directly on a polarizer. In FIG. 1, an adhesive layer 5 is previously coated on the polarizer 3, and a polypropylene resin melt 1 is formed into a film thereon according to an extrusion method (FIG. 1, left side). The formed polypropylene resin is solidified to give a protection film 4.

Alternatively, the protection film 4 may be previously formed according to a T-dye method, while on the other hand, the adhesive layer 2 is previously applied onto the polarizer 3, and they may be stuck together.

In the present invention, it is desired that the retardation Rth of the optical film in the thickness direction thereof is nearly the same as Rth, 45 nm, of a TAC film (thickness 80 μm) heretofore used in the property, in consideration of the case of using it as a protection film for polarizer, as combined with TAC. For using the optical film as a protection film for polarizer, the retardation Rth of the optical film in the thickness direction thereof is preferably within a range of from 20 to 60 nm, more preferably from 20 to 50 nm. The retardation Rth of the optical film in the thickness direction thereof may be controlled to fall within a desired numerical range by controlling the film thickness in accordance with Rth of TAC to be combined with it.

### [Polarizing Film]

The polarizing film of the present invention comprises the above-mentioned optical film of the present invention stuck to one surface or both surfaces of a polarizer. In this, the optical film is stuck to the polarizer and functions as a protection film.

The polarizer for use in the polarizing film of the present invention may be any one having the function of transmitting a light alone that a specific oscillation direction, and for example, includes a polyvinyl alcohol-based polarizer prepared by stretching a polyvinyl alcohol-based film or the like followed by dyeing it with iodine, a dichroic dye or the like; a polyene-based polarizer of a dehydrated product of polyvinyl alcohol or a dehydrochlorinated product of polyvinyl chloride; a reflection-type polarizer with a cholesteric liquid crystal; a thin crystal film-based polarizer, etc. Of those, preferred is a polyvinyl alcohol-based polarizer.

The polyvinyl alcohol-based polarizer includes, for example, one produced by making a hydrophilic polymer film, such as a polyvinyl alcohol-based film, a partially-formalized polyvinyl alcohol-based film, a partially-saponified ethylene/vinyl acetate copolymer-based film or the like, adsorb a dichroic substance such as iodine or dichroic dye followed by monoaxially stretching it. Of those, preferred for use herein is a polarizer comprising a polyvinyl alcohol-based film and a dichroic substance such as iodine. Not specifically defined, the thickness of the polarizer may be generally from 1 to 100 μm or so.

The PVA resin favorably used as a resin to constitute the polarizer may be produced through saponification of a polyvinyl acetate-based resin. The polyvinyl acetate-based resin includes, for example, polyvinyl acetate, a homopolymer of vinyl acetate, as well as a copolymer of vinyl acetate with any other monomer copolymerizable with it. The other monomer to copolymerize with vinyl acetate includes, for example, unsaturated carboxylic acids, olefins, vinyl ethers, unsaturated sulfonic acids, etc.

The degree of saponification of the PVA-based resin may be generally from 85 to 100 mol %, preferably from 98 to 100 mol %. The PVA-based resin may be further modified, and, for example, aldehyde-modified polyvinyl formal and polyvinyl acetal are usable herein. The degree of polymerization of the PVA-based resin may be generally from 1,000 to 10,000, preferably from 1,500 to 10,000.

The polarizing film may be produced in a process comprising a step of monoaxially stretching the above-mentioned PVA-based resin film, a step of dyeing the PVA-based resin film with a dichroic colorant so that the film adsorbs the dichroic colorant, a step of processing the dichroic colorant-adsorbed PVA-based resin film with an aqueous boric acid solution, a step of washing it after treatment with the aqueous boric acid solution, and a step of sticking a protection film to the monoaxially-stretched PVA-based resin film with the dichroic colorant adsorbed and oriented therein through the previous steps.

The monoaxial stretching treatment may be attained prior to the dyeing with a dichroic colorant, or simultaneously with the dying with a dichroic colorant, or may be attained after the dyeing with a dichroic colorant. In case where the monoaxial stretching is attained after the dyeing with a dichroic colorant, the monoaxial stretching may be attained prior to the treatment with boric acid, or during the treatment with boric acid. The monoaxial stretching may be attained in these plural steps. For the monoaxial stretching, the film may be monoaxially stretched between rolls running at a different peripheral speed, or may be monoaxially stretched with a hot roll. It may be dry stretching to be attained in air, or may be wet stretching of stretching the film while swollen with a solvent. The draw ratio in stretching may be generally from 4 to 8 times or so.

In case where a PVA-based resin film is dyed with a dichroic colorant, for example, the PVA-based resin film may be dipped in an aqueous solution of a dichroic colorant. As the dichroic colorant, concretely used is iodine or a dichroic dye.

In case where iodine is used as the dichroic colorant, generally employed is a method of dipping a PVA-based resin film in an aqueous solution containing iodine and potassium iodide for dyeing it. The iodine content of the aqueous solution may be generally from 0.01 to 0.5 parts by mass or so relative to 100 parts by mass of water; and the potassium iodide content may be generally from 0.5 to 10 parts by mass or so relative to 100 parts by mass of water. The temperature of the aqueous solution may be generally from 20 to 40° C. or so, and the dipping time in the aqueous solution may be generally from 30 to 300 seconds or so.

On the other hand, in case where a dichroic dye is used as the dichroic colorant, generally employed is a method of dipping a PVA-based resin film in an aqueous solution containing a water-soluble dichroic dye for dyeing it. The content of the dichroic dye in the aqueous solution may be generally from 1×10⁻³ to 1×10⁻² parts by mass or so relative to 100 parts by mass of water. The aqueous solution may contain an inorganic salt such as sodium sulfate. The temperature of the aqueous solution may be generally from 20 to 80° C. or so, and the dipping time in the aqueous solution may be generally from 30 to 300 seconds or so.

The treatment with boric acid after the dyeing with a dichroic colorant may be attained by dipping the dyed PVA-based resin film in an aqueous solution of boric acid. The boric acid content of the aqueous boric acid solution may be generally from 2 to 15 parts by mass or so relative to 100 parts by mass of water, preferably from 5 to 12 parts by mass or so.

In case where iodine is used as the dichroic colorant, the aqueous boric acid solution preferably contains potassium iodide. The potassium iodide content of the aqueous boric acid solution may be generally from 2 to 20 parts by mass relative to 100 parts by mass of water, preferably from 5 to 15 parts by mass. The dipping time in the aqueous boric acid solution may be generally from 100 to 1,200 seconds or so, preferably from 150 to 600 seconds or so, more preferably from 200 to 400 seconds or so. The temperature of the aqueous boric acid solution may be generally at least 50° C., preferably from 50 to 85° C.

After the treatment with boric acid, the PVA-based resin film is generally washed with water. The washing treatment with water may be attained, for example, by dipping the boric acid-processed PVA-based resin film in water. After the washing with water, the film is dried to be a polarizer. The water temperature in the washing treatment with water may be generally from 5 to 40° C. or so; and the dipping time may be generally from 2 to 120 seconds or so. The subsequent drying treatment may be attained generally with a hot air drier or a far-IR heater. The drying temperature may be generally from 40 to 100° C. The treatment time for the drying treatment may be generally from 120 to 600 seconds or so.

In the manner as above, a polarizer of an iodine or dichroic dye-adsorbed, oriented PVA-based resin film can be produced.

### [Adhesive Layer]

The optical film may be stuck to a polarizer via an adhesive in the manner mentioned above.

The adhesive to constitute the adhesive layer includes a PVA-based adhesive, an epoxy-based adhesive, an acrylic adhesive, a polyolefin-based adhesive such as a polyolefin grafted with an unsaturated carboxylic acid or its anhydride or a blend of the grafted polyolefins, etc. In addition, also usable is a transparent adhesive, for example, a polyvinyl ether-based adhesive, a rubber-based adhesive, etc. Above all, preferred is a PVA-based adhesive.

The PVA-based adhesive comprises a PVA-based resin and a crosslinking agent. The PVA-based resin includes, for example, PVA obtained through saponification of polyvinyl acetate and its derivative, a saponified product of a copolymer of vinyl acetate and a copolymerizable monomer, a modified PVA prepared through acetalization, urethanation, etherification, grafting or phosphorylation of PVA, etc. One or more such PVA-based resins may be used herein either singly or as combined. The monomer copolymerizable with vinyl acetate includes unsaturated carboxylic acids and their ester such as maleic acid (anhydride), fumaric acid, crotonic acid, itaconic acid, (meth)acrylic acid, etc.; α-olefins such as ethylene, propylene, etc.; (meth)allylsulfonic acid (sodium salt), sodium sulfonate (monoalkyl maleate), sodium disulfonate alkyl maleate, N-methylolacrylamide, acrylamide alkyl sulfonate alkali salts, N-vinylpyrrolidone, N-vinylpyrrolidone derivatives, etc.

Not specifically defined, the mean degree of polymerization of the PVA-based resin is preferably from 100 to 3000 or so, more preferably from 500 to 3000, and the mean degree of saponification thereof is preferably from 85 to 100 mol % or so, more preferably from 90 to 100 mol % or so, from the viewpoint of good adhesiveness of the resin.

The epoxy-based adhesive includes a hydrogenated epoxy resin, an alicyclic epoxy resin, an aliphatic epoxy resin, etc. The epoxy resin may further contain a compound of promoting cationic polymerization such as oxetanes, polyols, etc.

As the acrylic adhesive, especially preferred are those comprising, as the main ingredient thereof, a copolymer of an acrylate such as butyl acrylate, ethyl acrylate, methyl acrylate, 2-ethylhexyl acrylate or the like and an α-monoolefin-carboxylic acid such as acrylic acid, maleic acid, itaconic acid, methacrylic acid, crotonic acid or the like (including those with a vinyl monomer such as acrylonitrile, vinyl acetate or styrol added thereto), as not detracting from the polarizing performance of polarizers.

As the adhesive, also usable are polyolefins grafted with an unsaturated carboxylic acid or its anhydride, and blends of such grafted polyolefins. The polyolefin to be grafted includes, for example, low-density polyethylene, high-density polyethylene, polypropylene, poly-1-butene, poly-4-methyl-1-pentene, ethylene/propylene copolymer, ethylene/1-butene copolymer, propylene/1-butene copolymer, and their mixtures. The unsaturated carboxylic acid and its anhydride for grafting the polyolefin include acrylic acid, methacrylic acid, maleic acid, maleic anhydride, citraconic acid, citraconic anhydride, itaconic acid, itaconic anhydride, etc. Thus prepared, the modified polyolefin may be used directly as it is, or may be blended with a polyolefin.

The adhesive layer may be formed by applying the adhesive to one or both sides of any of the optical film or a polarizer. The thickness of the adhesive layer is preferably from 0.01 to 10 μm, more preferably from 0.03 to 5 μm.

In sticking the optical film to a polarizer, the surface of the optical film to face the polarizer may be processed for adhesiveness-enhancing treatment for the purpose of enhancing the adhesiveness of the processed surface. The adhesiveness-enhancing treatment includes surface treatment such as corona treatment, plasma treatment, low-pressure UV treatment, saponification or the like, as well as a method of forming an anchor layer, and these may be combined if desired. Of those, preferred are corona treatment, a method of forming an anchor layer, and their combination.

Next, an adhesive layer is formed on the adhesiveness-enhanced surface as described above, and an optical film of the present invention is stuck to the polarizer via the adhesive layer. The two may be stuck together, using a roll laminator or the like. The heating and drying temperature and the drying time may be suitably determined depending on the type of the adhesive.

The polarizing film of the present invention comprises a polarizer and an optical film of the present invention stuck to at least one surface of the polarizer and serving as a protection film for the polarizer, in which, if desired, an optical film of the present invention may be further laminated on the other surface of the polarizer, or any other resin film may be laminated thereon. The other resin film includes, for example, a fumaric diester-based resin, a triacetyl cellulose film, a polyether sulfone film, polyarylate film, a polyethylene terephthalate film, a polynaphthalene terephthalate film, a polycarbonate film, a cyclic polyolefin film, a maleimide-based resin film, a fluororesin film, etc. The other resin film may be a retardation film having a specific retardation.

Preferably, the polarizing film of the present invention has at least one hard coat layer for improving the surface condition and the scratch resistance thereof. The hard coat layer may comprise, for example, a silicone-based resin, an acrylic resin, an acrylsilicone-based resin, a UV-curable resin, an urethane-based hard coat agent, etc. Of those, preferred is a hard coat layer comprising a UV-curable resin from the viewpoint of the transparency, the scratch resistance, and the chemical resistance. One or more these hard coat layers may be used herein.

The UV-curable resin is, for example, at least one selected from UV-curable acrylic urethanes, UV-curable epoxy acrylates, UV-curable (poly)ester acrylates, UV-curable oxetanes, etc.

Preferably, the thickness of the hard coat layer is from 0.1 to 100 μm, more preferably from 1 to 50 μm, even more preferably from 2 to 20 μm. Below the hard coat layer, the polarizing film may be processed for primer coating thereon.

If desired, the polarizing film of the present invention may be processed for known antiglare treatment for antireflection or for reflection reduction.

### [Image Display Device]

The polarizing film having an optical film of the present invention on at least one surface thereof may be used, for example, as stuck to a liquid-crystal cell. FIG. 2 shows a constitution example of a liquid-crystal cell having an optical film and a polarizing film of the present invention. In FIG. 2, 6 is a liquid-crystal cell. Examples of the liquid-crystal cell 6 include active matrix-driving mode cells such as typically thin-film-transistor mode cells, and simple matrix-driving mode cells such as typically twisted nematic mode cells, super-twisted nematic mode cells, etc. The constitution example of the liquid-crystal cell of FIG. 2 comprises the liquid-crystal cell 6, a retardation film 8 laminated thereon via an adhesive layer (not shown—the same shall apply hereinunder), and a polarizing film 7 of the present invention further laminated thereon via an adhesive layer (not shown). In this, the optical element 2 comprises the retardation film 8 and the polarizing film 7 laminated thereon; and the polarizing film 7 has a polarizer 3 in the center thereof, and has a protection film 4 formed of an optical film of the present invention, as laminated on both surfaces of the polarizer via an adhesive layer 5. In laminating the polarizing film 7 of the present invention and the retardation film 8, and laminating the retardation film 8 and the liquid-crystal cell 6, an adhesive layer may be previously given to the polarizing film 7, the retardation film 8 and the liquid-crystal cell 6.

The adhesive for laminating the polarizing film of the present invention and the liquid-crystal cell is not specifically defined, for which, for example, a base polymer may be suitably selected from a polymer of an acrylic polymer, a silicone-based polymer, a polyester, a polyurethane, a polyamide, a polyether, a fluoropolymer, a rubber polymer or the like. Above all, preferred is an acrylic adhesive as excellent in optical transparency, having good adhesive characteristics of suitable wettability, cohesiveness and adhesiveness and excellent in weather resistance and heat resistance.

The adhesive is required to be excellent in optical transparency, to have good adhesive characteristics of suitable wettability, cohesiveness and adhesiveness and to be excellent in weather resistance and heat resistance. Further, the adhesive layer is required to have a low moisture absorption and have excellent heat resistance from the viewpoint of preventing a foaming phenomenon and a peeling phenomenon to be caused by moisture absorption, preventing the reduction in the optical properties of the layer and deformation of the liquid-crystal cell owing to the thermal expansion difference therebetween or the like, and securing formability of image display devices of high quality and excellent durability. From these standpoints, preferred is an acrylic adhesive.

The adhesive may contain natural and synthetic resins, especially adhesiveness-imparting resins, fillers of glass fibers, glass beads, metal powder or any other inorganic powder, and other additives such as pigment, colorant, antioxidant, etc. Containing fine particles, the adhesive layer may have the ability of diffusing light.

Not specifically defined, the adhesive may be applied to the polarizing film of the present invention in any suitable manner. For example, employable is a method of dissolving or dispersing a base polymer or its composition in a single solvent or a mixed solvent of suitable solvents such as toluene, ethyl acetate and the like to prepare an adhesive solution or dispersion of from 10 to 40% by mass or so, and applying it directly onto a polarizing film of the present invention according to a suitable spreading mode of a casting mode or a coating mode thereon, or a method of forming an adhesive layer on a releasable base film according to that method and transferring it onto a polarizing film of the present invention.

For the coating method, employable are various methods of gravure coating, bar coating, roll coating, reverse roll coating, comma coating or the like; but a gravure coating method is the most popular one.

The adhesive layer may be have a multilayer structure of different compositions or types of adhesives, as formed on one or both surfaces of the polarizing film of the present invention. In case where the layer is formed on both surfaces of the polarizing film of the present invention, the adhesive may not have the same composition on both the surface and the back of the polarizing film, and the adhesive layer may not have the same thickness on the two. Adhesive layers having a different composition and a different thickness may be formed.

The thickness of the adhesive layer may be suitably determined depending on the purpose of use and the adhesive power thereof, and in general, it may be from 1 μm to 500 μm, preferably from 5 μm to 200 μm, more preferably from 10 μm to 100 μm.

Preferably, the exposed surface of the adhesive layer is temporarily covered with a release film for the purpose of preventing it from being polluted before use in practice. Accordingly, the adhesive layer may be protected from direct contact in ordinary handling conditions. The release film may be any known one, including, for example, thin sheet-like substances such as plastic film, rubber sheet, paper, fabric, nonwoven fabric, net, foam sheet, metal foil or their laminate, optionally coated with a suitable lubricant such as silicone-based lubricants, long-chain alkyl-based lubricants, fluorine-containing lubricants, molybdenum sulfide, etc.

In the present invention, the polarizer, and the constitutive layers of the protection film layer, the adhesive layer and others may be processed for making them have UV absorbability, for example, according to a method of processing them with an UV absorbent such as salicylate compounds, benzophenol compounds, benzotriazole compounds, cyanoacrylate compounds, nickel complex compounds, etc.

The polarizing film of the present invention is favorably used in producing various devices such as image display devices, etc. The image display devices include liquid-crystal display devices containing a liquid-crystal cell, organic EL display devices, touch panels, etc.; and not specifically defined, the image display devices may be any ones having a polarizing film therein. A liquid-crystal display device is generally produced by suitably assembling the constitutive components such as a liquid-crystal cell, an optical film and optionally a lighting system, etc., with incorporating a driving circuit thereinto; and in the present invention, the constitution of the image display device is not specifically defined except that the above-mentioned polarizing film is incorporated in the device. For example, suitable image display devices may be mentioned such those where a polarizing film is disposed on one side or both sides of the liquid-crystal cell and those where a backlight or a reflector plate is incorporated as the lighting system. The liquid-crystal cell may be any known one, including, for example, a TN-mode cell, an STN-mode cell, a π-mode cell, etc. In constructing the image display device, for example, at least one or more layers of suitable components of a diffuser plate, an antiglare layer, an antireflection film, a protective plate, a prism array, a lens array sheet, a light-diffusing plate, a backlight and others may be disposed in suitable positions.

### [Application to Organic EL Display Device]

The polarizing film of the present invention may be favorably applied to an organic EL display device.

In general, an organic EL display device comprises an emitter (organic electroluminescent emitter) formed by laminating a transparent electrode, an organic light emission layer and a metal electrode in that order on a transparent substrate. In this, the organic light emission layer is a laminate of various organic thin films, for which, for example, known are various combined constitutions of a laminate of a hole injection layer comprising a triphenylamine derivative or the like and a light emission layer comprising a fluorescent organic solid of anthracene or the like; a laminate of such a light emission layer and an electron injection layer comprising a perylene derivative or the like; a laminate comprising such a hole injection layer, alight emission layer and an electron injection layer, etc.

The organic EL display devices emits light according to a principle of such that holes and electrons are injected into the organic light emission layer through voltage application to the transparent electrode and the metal electrode, then the energy generated through recombination of the hole and the electron excites the fluorescent substance in the layer and the excited fluorescent substance emits radiation when it is restored to the ground state thereof. The mechanism of recombination in the course of the process is the same as that in an ordinary diode; and as will be estimated from this, the current and the emission intensity show strong non-linearity accompanied with rectification relative to the applied voltage.

In the organic EL display device, at least one electrode must be transparent for taking out the light emitted by the organic light emission layer, in which, therefore, a transparent electrode formed of a transparent conductor such as indium tin oxide (ITO) or the like is generally used as the anode. On the other hand, for facilitating electron injection to increase the light emission efficiency, it is important to use a substance having a small work function as the cathode, and in general, a metal electrode of Mg—Ag, Al—Li or the like is used for it.

In the organic EL display device having the constitution as above, the organic light emission layer is formed of an extremely thin film having a thickness of about 10 nm or so. Accordingly, like the transparent electrode, the organic light emission layer also completely transmits light therethrough. As a result, in the absence of light emission from the device, the light having entered the device through the surface of the transparent substrate, then having passed through the transparent electrode and the organic light emission layer and having been reflected on the metal electrode again goes out of the device on the side of the surface of the transparent substrate, and therefore, when seen from the outside, the panel surface of the organic EL display device looks like a mirror surface.

In the organic EL display device comprising a transparent electrode on the surface side of the organic light emission layer that emits light through voltage application thereto and comprises an organic electroluminescent emitter with a metal electrode on the back side of the organic light emission layer, a polarizing film of the present invention may be provided on the surface side of the transparent electrode and a birefringence layer (retardation film) may be provided between the transparent electrode and the polarizing film.

The polarizing film of the present invention has a function of polarizing the external incident light reflected on the metal electrode, and is therefore effective for not visualizing the mirror surface of the metal electrode from the outside owing to its polarizing function. In particular, when the birefringence layer is formed of a λ/4 plate and the angle of the polarizing direction between the polarizing film and the birefringence layer is controlled to be π/4, then the mirror surface of the metal electrode can be completely blocked.

Specifically, of the external incident light into the organic EL display device, only the linear polarized component can transmit owing to the polarizing film in the device. The linear polarization is generally elliptic polarization owing to the birefringence layer, but when the birefringence layer is a λ/4 plate and when the angle between the polarizing film and the polarization direction is π/4, then the linear polarization is circular polarization. The circularly polarized light passes through the transparent substrate, the transparent electrode and the organic thin film, then reflects on the metal electrode and again passes through the organic thin film, the transparent electrode and the transparent substrate, thereby again forming a linearly polarized light through the birefringence layer. Since the linearly polarized light is perpendicular to the polarization direction of the polarizing film, it could not pass through the polarizing film. As a result, the mirror surface of the metal electrode can be completely blocked.

### [Application to Touch Panel]

The optical film of the present invention is favorably applicable to the polarizing film of a touch panel. In general, a touch panel is such that an operator touches the transparent surface provided on the top of the display panel thereof with a pen or a finger thereof to thereby operate the device and the system. Direct touch of the panel surface is more direct and more intuitive, as compared with the operation of determining the position by pushing the cursor with a direction key, and has become much used these days. In addition, recently, the growth of a mobile terminal market for mobile phones, PDA (personal digital assistants) and others is remarkable, and the devices are required to be visible under sunlight and to be thin and lightweight. Various types of touch panels are known, and are differentiated for their use depending on their advantages and disadvantages. Touch panels include various types of resistance-film type, optical type, capacitance coupling type (also referred to as analogue capacitive coupling type), IR type, ultrasonic type, electromagnetic conduction type, etc. An example of a resistance-film type touch panel is described below.

A resistance-film type touch panel includes a glass/glass type and a glass/film type. The glass/glass type comprises a transparent conductive layer-attached glass substrate and a transparent conductive layer-attached glass substrate held together via a space therebetween, and this is stuck to the display surface. The glass/film type is for an on-vehicle or portable touch panel and is desired to be more lightweight and thinner, in which the upper transparent conductive layer-attached glass substrate is substituted with an optical film.

FIG. 3 shows a glass/glass type touch panel; and FIG. 4 shows a glass/film type touch panel. The glass/glass type touch panel and the glass/film type touch panel are described below with reference to FIG. 3 and FIG. 4.

When a linear polarizing film or a circular polarizing film comprising a laminated combination of a polarizing film and a λ/4 plate is used as the outermost surface of a touch panel, then the touch panel may have a sufficient strength and its visibility is enhanced owing to the effect of antireflection. In the touch panel, the polarizing film is 9 in FIGS. 3 and 17 in FIG. 4. As the polarizing film in these touch panels, the optical film of the present invention is favorably used.

When a polarizing film comprising an optical film of the present invention and a polarizer, and a λ/4 plate are laminated in such a manner that the angle between the in-plane slow axis of the λ/4 plate and the polarization axis of the polarizing film is substantially 45°, then a circular polarizing film can be produced. Substantially 45° is meat to include from 40 to 50°. Preferably, the angle between the in-plane slow axis of the λ/4 plate and the polarization axis of the polarizing film is from 41 to 49°, more preferably from 42° to 48°, even more preferably from 43 to 47°, most preferably from 44 to 46°.

The optical film of the present invention may be used as any of the upper, lower or lower outer protection film of the polarizing film (film for weight reduction to be provided with ITO). For antireflection of touch panels, there are known a linear polarization type and a circular polarization type (the linear polarization type has a higher refractive index than the circular polarization type), and the optical film of the present invention may be used in any of circular polarization-type and linear polarization-type polarizing films.

The circular polarizing film and the linear polarizing film comprising the optical film of the present invention may be used for any of transmission-type and reflection-type touch panels.

### EXAMPLES

The present invention is described in more detail with reference to the following Examples and Comparative Examples; however, the present invention should not be limited by these Examples.

### (Evaluation Methods)

### 1. Modulus of Bending Elasticity:

Measured according to JIS K7171.

### 2. Determination of MFR:

Using a melt indexer (Model F-W01, by Toyo Seiki Seisakusho), MFR of a sample was measured at 230° C. and under a load of 2.16 kg, according to JIS K7210.

### 3. Tensile Strength:

Measured according to ASTM D638.

4. Evaluation of in-plane Retardation:

Using a retardation meter (KOBRA-WR, by Oji Scientific Instruments), the in-plane retardation of a sample was measured at a wavelength of 589.3 nm and at an incident angle of 0 degree.

5. Transparency (haze):

Measured according to JIS K7105.

### 6. Heat Resistance and Moisture Resistance:

The optical film obtained in Example 1 and Comparative Example 1 was stuck to both surfaces of a polarizer formed of an iodine-adsorbed, oriented polyvinyl alcohol-based resin film, using, as an adhesive, PVA that had been prepared by saponifying polyvinyl acetate, thereby producing polarizing films.

A test piece of 150 mm square was cut out of the polarizing film, and kept at 90° C. for 1,000 hours for evaluation of the heat resistance thereof, and thereafter its outward appearance was checked. The samples with neither deformation nor discoloration are good (O), and those with any of deformation or discoloration are bad (x).

For evaluation of the moisture resistance thereof, the polarizing film was kept at 70° C. and a relative humidity of 95% for 1,000 hours, and thereafter its outward appearance was checked. The samples with neither deformation nor discoloration are good (O), and those with any of deformation or discoloration are bad (x).

### 7. Determination of Rth:

The optical film obtained in Examples 1 to 3 and Comparative Example 2 was analyzed with a retardation meter (KOBRA-WR, by Oji Scientific Instruments) for the angle-dependent retardation at a wavelength of 589.3 nm and at an incident angle of from −50 to 50° at intervals of 10°. Based on the found data, the retardation Rth of the optical film in the thickness direction was computed.

### Example 1

A polypropylene resin produced with a metallocene catalyst (Nippon Polypro's trade name, Wintec, having a modulus of bending elasticity of 900 MPa and a melting point of 142° C.—hereinafter referred to as “mPP-A”) was formed into an optical film through T-die single-layer extrusion to have a thickness of 100 μm, at a working temperature of 200° C. and at a take-up roll temperature of 50° C.

The optical film was evaluated according to the above-mentioned evaluation methods. The results are shown in Table 1. The found data of Rth is shown in Table 2.

### Example 2

An optical film was produced in the same manner as in Example 1, for which, however, a polypropylene resin produced with a metallocene catalyst (Nippon Polypro's trade name, Wintec, having a modulus of bending elasticity of 1200 MPa and a melting point of 135° C.—hereinafter referred to as “mPP-B”) was used in place of mPP-A used in Example 1. This was evaluated in the same manner as in Example 1, and the results are shown in Table 1 and Table 2.

### Example 3

An optical film was produced in the same manner as in Example 1, for which, however, a di-substituted dibenzylidene sorbitol-based nucleating agent master batch (Riken Vitamin's trade name, Rikemaster PN-10R; nucleating agent content, 10% by mass) was added to mPP-A used in Example 1 in an amount of 1 part by mass relative to 100 parts by mass of mPP-A (transparent nucleating agent content, 0.1 parts by mass). This was evaluated in the same manner as in Example 1, and the results are shown in Table 1 and Table 2.

### Example 4

An optical film was produced in the same manner as in Example 1, for which, however, a polypropylene resin produced with a metallocene catalyst (Nippon Polypro's trade name, Wintec, having a modulus of bending elasticity of 700 MPa and a melting point of 125° C.—hereinafter referred to as “mPP-C”) was used in place of mPP-A used in Example 1. This was evaluated in the same manner as in Example 1, and the result is shown in Table 1.

### Comparative Example 1

An optical film was produced in the same manner as in Example 1, for which, however, a polypropylene resin produced with a Ziegler catalyst (Primer Polymer's trade name, Prime Polypro, having a modulus of bending elasticity of 1100 MPa and a melting point of 135° C.—hereinafter referred to as “random PP”) was used in place of mPP-A used in Example 1. This was evaluated in the same manner as in Example 1, and the result is shown in Table 1.

TABLE 1

| | | Dibenzylidene | | Modulus | | | | | |
|---|---|---|---|---|---|---|---|---|---|
| | Polypropylene | Sorbitol-based | | of Bending | Tensile | In-plane | | | |
| | Resin | Additive | MFR | Elasticity | Strength | Retardation | Haze | Heat | Moisture |
| | (100 mas.pts.) | (mas.pt.) | (g/10 min) | (MPa) | (MPa) | (nm) | (%) | Resistance | Resistance |
| Example 1 | mPP-A | — | 24 | 900 | 30.5 | 4 | 6 | ∘ | ∘ |
| Example 2 | mPP-B | — | 30 | 1200 | 35.0 | 5 | 9 | — | — |
| Example 3 | mPP-A | 0.1 | 24 | 900 | 36.6 | 8 | 3 | — | — |
| Example 4 | mPP-C | — | 15 | 700 | 29.5 | 5 to 27*¹ | 3 | — | — |
| Comparative | random PP | — | 25 | 1100 | 30.0 | 25 | 20 | x | x |
| Example 1 | | | | | | | | | |

*¹Since stress was given to the film edges, the in-plane retardation fluctuated in the production method of the Examples; however, the samples of the lot having a low in-plane retardation were practicable as polarizing films.

It was shown that the optical films obtained in Examples 1 to 3 had excellent properties. In Example 4, stress tended to be given to the film edges and the in-plane retardation fluctuated from 5 to 27 nm but fell within a small region; and therefore it is shown that the optical film is usable as s. On the other hand, the optical film obtained in Comparative Example 1 had an in-plane retardation of 25 nm and was much higher than 10 nm, and it is shown that the film is unsuitable to use for polarizing films.

### Comparative Example 2

Rth of a commercial TAC film (Fujitac, trade name by FUJIFILM, having a thickness of 80 μm) was measured according to the above-mentioned method. The found data is shown in Table 2.

TABLE 2

| | Polypropylene Resin | Rth |
|---|---|---|
| | (100 mas.pts.) | (nm) |
| Example 1 | mPP-A | 36 |
| Example 2 | mPP-B | 40 |
| Example 3 | mPP-A | 57 |
| Comparative | TAC | 45 |
| Example 2 | | |

Rth of the polypropylene resin film used in Examples 1 to 3 was on the same level as that of Rth of the commercial TAC film, which shows that the retardation level of the former is the same as that of the TAC film.

### INDUSTRIAL APPLICABILITY

According to the present invention, there is provided an optical film having excellent optical properties such as small haze, excellent transparency and small birefringence, having good mechanical strength and heat resistance, excellent in water vapor transmission rate and suitable as a protection film for polarizers. In addition, the optical film of the present invention is excellent in various durability such as heat resistance, wet heat resistance and thermal shock cycle, and can improve the degree of polarization of polarizing films not having any influence on the optical function of the polarizing films, and further, it is soft and rich in flexibility.

Moreover, the optical film of the present invention is resistant to external shock and deformation, and therefore, when the optical film is stuck to a polarizer, then it may provide a polarizing film with which the liquid-crystal display element may have noticeably enhanced strength and reliability.

Further, when compared with a TAC film heretofore popularly used in the property, the optical film of the present invention is hydrophobic though the TAC film and is hydrophilic and has little water vapor transmission rate, and therefore, the optical film of the present invention can remarkably enhance the durability of polarizing films comprising it. Accordingly, the optical film of the present invention is favorably used as a protection film to be laminated on at least one surface of a polarizing film and stuck to the surface substrate of a liquid-crystal cell, and also as a protection film on the other side of the polarizing film.

1. An optical film for a protection film for a polarizer, comprising a polypropylene-based resin produced utilizing a metallocene catalyst.

2. The optical film as claimed in claim 1, wherein the polypropylene-based resin has a modulus of bending elasticity of at least 700 MPa.

3. The optical film as claimed in claim 1, wherein the polypropylene-based resin has a melt flow rate of at least 20 g/10 min., measured under the condition of 230° C. and 2.16 kg load according to JIS K7210.

4. The optical film as claimed in claim 1, wherein the optical film is an unstretched film.

5. The optical film as claimed in claim 1, wherein a dibenzylidene sorbitol-based additive is added to the resin in an amount of from 0.03 to 0.5 parts by mass relative to 100 parts by mass of the polypropylene-based resin.

6. The optical film as claimed in claim 1, wherein the optical film has a retardation in the thickness direction thereof of from 20 to 60 nm.

7. A polarizing film having the optical film of claim 1 formed on at least one surface of the polarizer therein.

8. An image display device comprising the polarizing film of claim 7.
